(19) United States
(12) Patent Application Publication
(10) Pub. No.: US 2004/0145079 A1
(43) Pub. Date: Jul. 29, 2004

(54) Composite material member having reinforcement ribs and method for making the same

(76) Inventors: Yung-Kun Lin, Taichung (TW); Yuder Chen, Taichung (TW); Ming-Jen Ting, Lung-Tang (TW); Tseng Chung Ko, Lung-Tang (TW); Chin-Kun Lee, Lung-Tang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/351,374

(22) Filed: Jan. 27, 2003

(51) Int. Cl. B29C 70/48

(52) U.S. Cl. 264/257; 264/258

(57) ABSTRACT

A method for making a composite material member having reinforcement ribs includes several basic units which are composed of a core which can be a foam material core, thermoplastic core or honeycomb structure core, and braided fabric are wrapped around the core. The basic units are arranged to be a desired shape or fashion and combined by another layer of braided fabric. A resin is added to connect the layers of the braided fabric as one so as to obtain a composite material member that has reinforcement ribs.

### FIELD OF THE INVENTION

The present invention relates to a composite material member that includes a plurality of basic sandwich structure units and an outer layer of fiber fabric and resin is mounted to the basic units so as to form a part with large area.

### BACKGROUND OF THE INVENTION

A conventional composite material member generally is made by way of resin transfer molding and the reinforcement ribs of the composite material member if needed are made individually. The reinforcement ribs are put in the mold and covered by fibers so as to connect the reinforcement ribs to the composite material member. This consumes a lot of time and labor effort. Each reinforcement rib needs a layer of braided fabric and resin so that the final product becomes a bulky member and is so heavy that the customers cannot accept.

### SUMMARY OF THE INVENTION

The primary object of the present invention is to fabricate a composite material member having reinforcement ribs. The composite material member includes a core that is wrapped with fiber fabric to form a basic unit and a pre-determined number of the basic units are put in the mold and wrapped with braided fabric. By way of resin transfer molding, the whole units are made to be a one-piece member so as to obtain a composite material member that has satisfied features and good quality.

Another object of the present invention is to provide a method for making the composite material member. The final product can be obtained by one-time-job without requiring additional steps so as to reduce the period of making the composite material member. The reinforcement ribs are already to connect to the main body of the composite material member by wrapping braided fabric so that the thickness and weight can be reduced.

Yet another object of the present invention is to reveal a economic way to produce the composite material member, wherein the fiber fabric, is like braided fabric are flexible so that it can be easily attached to the core and this is convenient for paving the fiber fabric. Almost no waste material of the braided fabric left.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flow chart to show the steps of the method of the present invention;

FIG. 2 shows a structure of a basic unit;

FIG. 3 is a cross sectional view of the first embodiment of the present invention;

FIG. 4 is a cross sectional view of the second embodiment of the present invention;

FIG. 5 is a cross sectional view of the third embodiment of the present invention;

FIG. 6 is a cross sectional view of the fourth embodiment of the present invention;

FIG. 7 is a cross sectional view of the fifth embodiment of the present invention;

FIG. 8 is a cross sectional view of the sixth embodiment of the present invention;

FIG. 9 is a cross sectional view of the seventh embodiment of the present invention; and

FIG. 10 is a cross sectional view of the eighth embodiment of the present invention.

### DETAILED DESCRIPTION OF THE PREFERRED EMBODIMENT

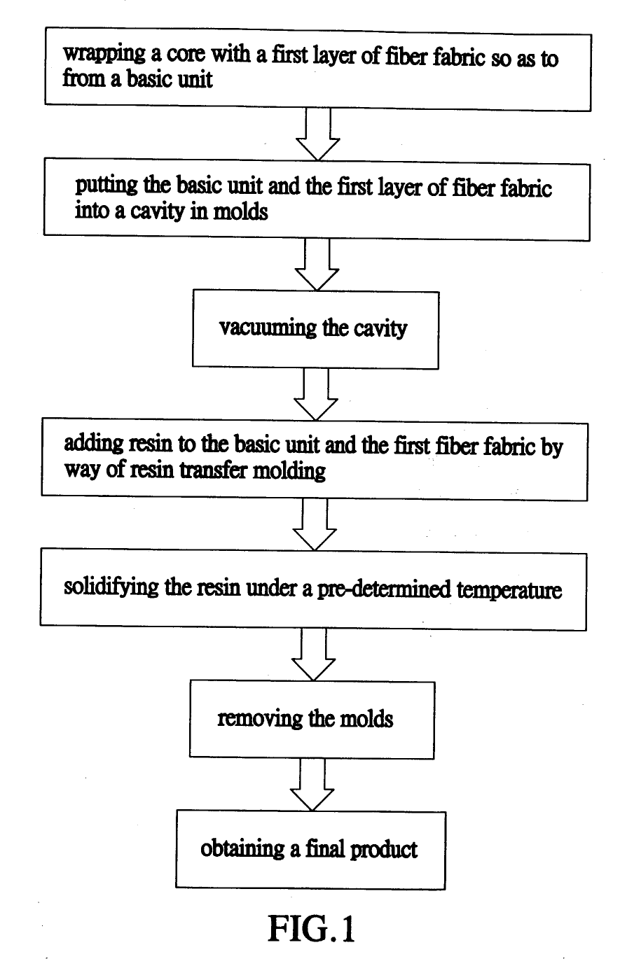

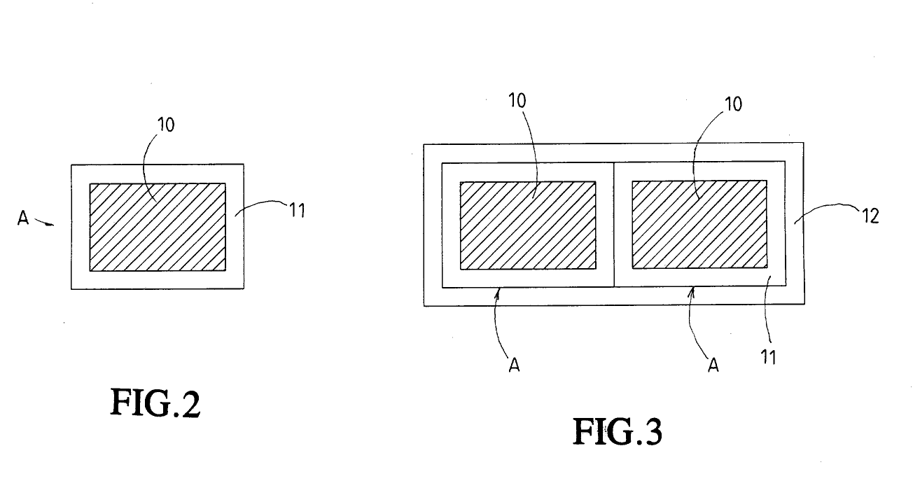

Referring to FIG. 1 which shows the steps of the method of the present invention and the method comprises step 1 of wrapping a core 10 with a first layer of braided fabric 11 so as to form a basic unit “A” as shown in FIG. 2; step 2 of putting the basic unit “A” and the outer layer of braided fabric 11 into a cavity in molds (not shown); step 3 of vacuuming the cavity; step 4 of adding resin to the whole units by way of resin transfer molding; step 5 of curing the resin under a pre-determined temperature; step 6 of removing the molds, and step 7 of obtaining the final product.

It is to be noted that the core 10 can be a hollow member, a solid member, a foam member, a honeycomb-structured member, a metal member, a thermoplastics member, or a thermosetting plastic member.

As shown in FIG. 3, a pre-determined number of the basic units “A” can be connected with each other by being wrapped with a outer (second) layer of braided fabric 12. The combination is then treated by proceeding step 2 to step 7 as previously described. Therefore, an elongated final product is obtained.

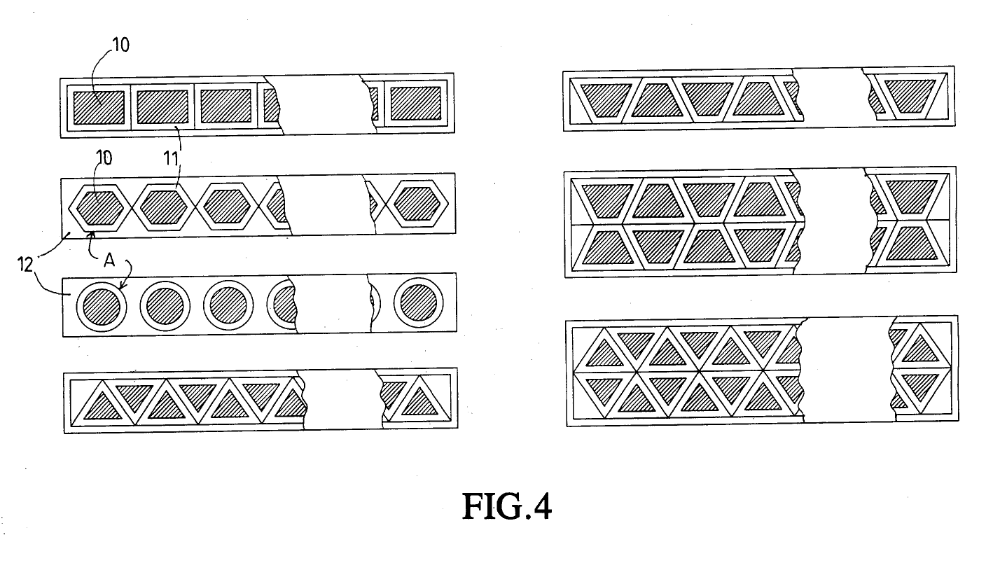

FIG. 4 shows that the shape of the core 10 can be varied according to need such as rectangular core, hexagonal core, circular core, triangular core or trapezoid core. The final product can be a single elongated final product or two overlapped elongated final products.

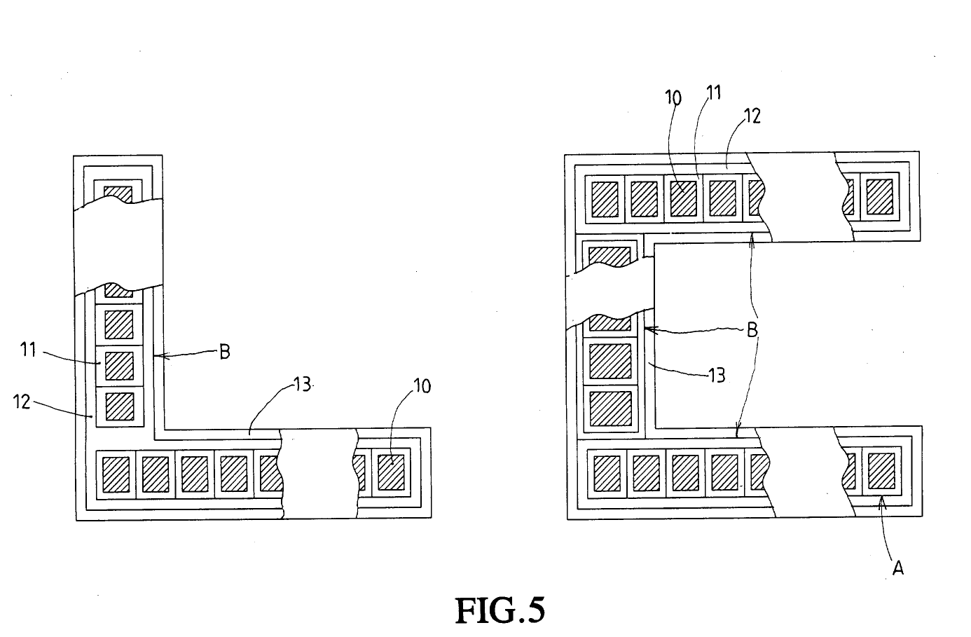

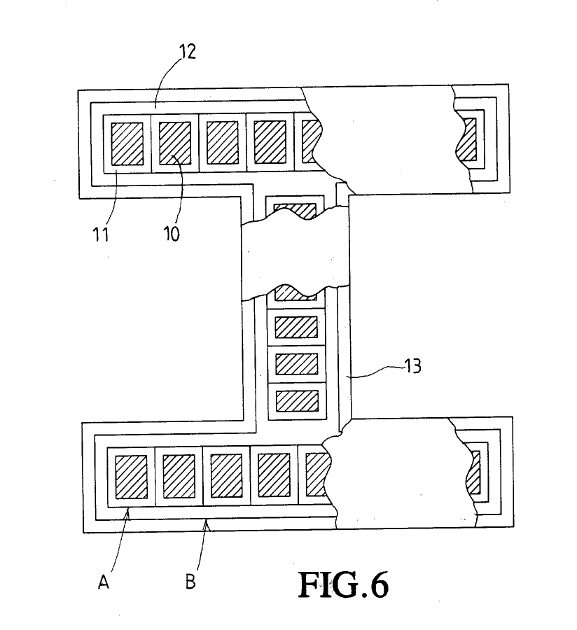

FIG. 5 shows that two elongated final products “B” can be connected as an L-shaped combination by a third layer of fiber fabric 13 and the L-shaped combination can be proceeded by the step 2 to step 7 as previously described. Three elongated final products “B” can be connected as a C-shaped combination by a third layer of fiber fabric 13. An I-shaped combination can be obtained as shown in FIG. 6 by connecting three elongated final products “B”.

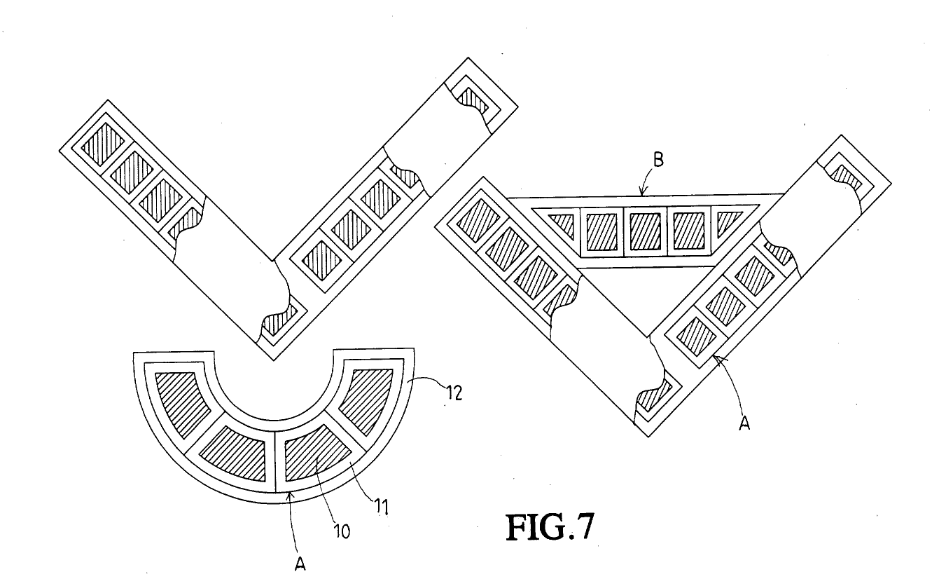

FIG. 7 shows that the basic units “A” can be arranged as a curved final product, a V-shaped final product, or an “A” shaped final product. The special shapes of the final products can be used in building a boat or ship.

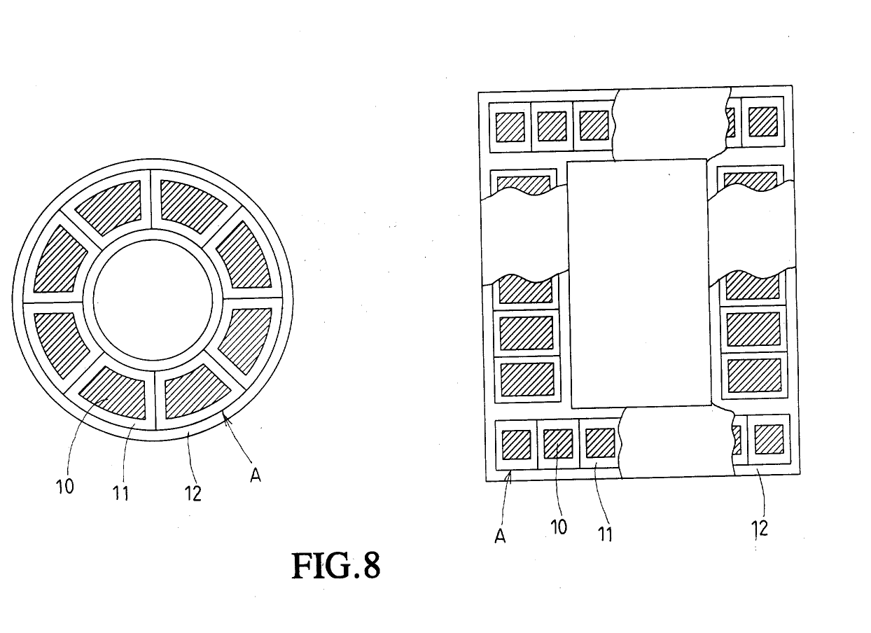

FIG. 8 shows that the basic units “A” can be arranged as a loop shaped final product or a hollow square frame. These final products can be used to build a main frame of a plane or an oil tank.

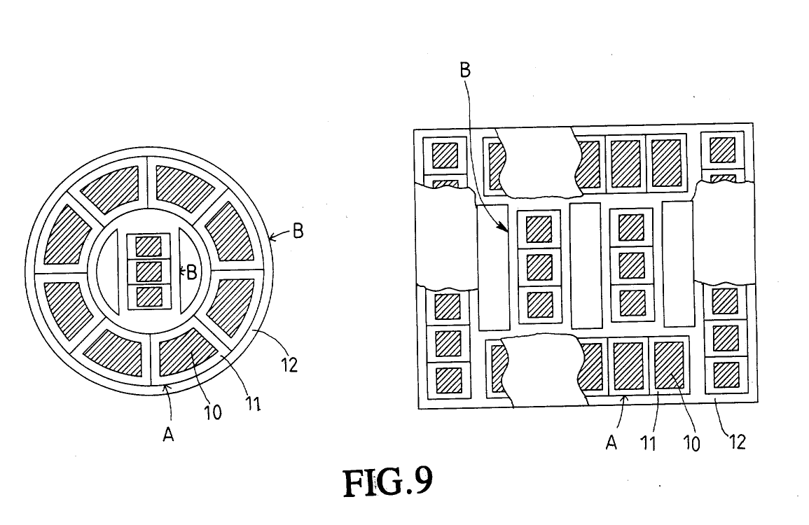

FIG. 9 shows a center piece is connected in the center of the loop shaped final product, and two reinforcement ribs “B” are connected between two opposite sides of the hollow square frame.

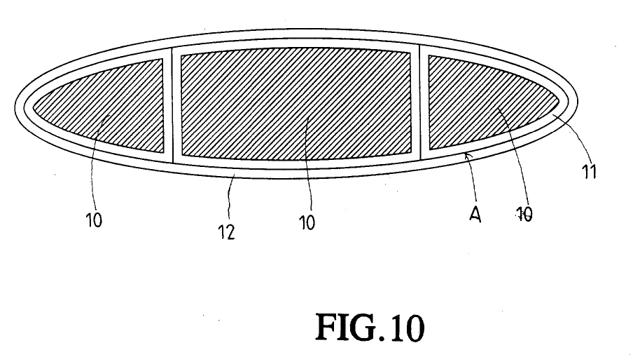

FIG. 10 shows that three different basic units “A” are arranged as a oval-shaped final product which can be used to build a wing of air planes, or rotor blades of helicopters.

The method has the following advantages:

1. The structural strength of the final products is satisfied and can be reinforced by adding more layers of braided fabric.

2. The weight of the final product is light and because the number of the layers of the braided fabric is limited so that the weight can be reduced. The fiber is flexible so that the fiber can be attached on the core and almost no waste material is left.

3. The resin transfer molding allows the final product to be completed within a short period of time.

4. The contour of the final products can be pre-set according needs.

While we have shown and described the embodiment in accordance with the present invention, it should be clear to those skilled in the art that further embodiments may be made without departing from the scope of the present invention.

What is claimed is:

1. A method for making a composite material member having reinforcement ribs, comprising:
step 1: wrapping a core with a first layer of braided fabric so as to form a basic unit;
step 2: putting the basic unit and the first layer of fiber fabric into a cavity in molds;
step 3: vacuuming the cavity;
step 4: adding resin to the basic unit and the first fiber fabric by way of resin transfer molding;
step 5: solidifying the resin under a pre-determined temperature;
step 6: removing the molds, and
step 7: obtaining a final product.

2. The method as claimed in claim 1, wherein two final products are combined by being wrapped by a second layer of fiber and resin is added onto the second layer of fiber.

3. The method as claimed in claim 1, wherein the core is a hollow member.

4. The method as claimed in claim 1, wherein the core is a solid member.

5. The method as claimed in claim 1, wherein the core is a foam member.

6. The method as claimed in claim 1, wherein the core is a honeycomb-structured member.

7. The method as claimed in claim 1, wherein the core is a metal member.

8. The method as claimed in claim 1, wherein the core is a thermoplastic member.

9. The method as claimed in claim 1, wherein the core is a thermosetting plastic member.
